(19) United States
(12) Patent Application Publication
(10) Pub. No.: US 2008/0259517 A1
(43) Pub. Date: Oct. 23, 2008

(54) Network Protector

(76) Inventors: Leon Kotze, Kliprivier (ZA); Alexander Franz Richter, Muldersdrift (ZA)

Correspondence Address: LADAS & PARRY LLP, 224 SOUTH MICHIGAN AVENUE, SUITE 1600, CHICAGO, IL, 60604, US

(21) Appl. No.: 10/592,974

(22) PCT Filed: Mar. 17, 2005
(86) PCT No.: PCT/IB05/00426

§ 371 Date: Jan. 10, 2007

(30) Foreign Application Priority Data
Mar. 17, 2004 (ZA) 2004/2141

(51) Int. Cl. H02H 1/04

(52) U.S. Cl. 361/119

(57) ABSTRACT

The invention provides a network protector (10) which comprises node connecting means (14) for connecting the network protector to a node (24) in an electronic network and hub connecting means (16) for connecting the network protector to a hub (22) in the electronic network. The network protector also includes a non-earthed surge protection circuit (28) for allowing electronic communication between the node connecting means and the hub connecting means. The surge protection circuit includes circuit breaking means (40, 42, 48, 50) for disrupting electronic communication between the node connecting means and the hub connecting means in response to electrical surges exceeding a specified value.

### BACKGROUND TO THE INVENTION

THIS invention relates to a network protector. In particular the invention is concerned with a network protector for disconnecting electronic communication, typically in the form of data, between a network port of a computer and a hub of a computer network. The invention also extends to a network protector for disconnecting electronic communication between a port of a first node in a computer network and a port of a second node in the computer network.

A computer network comprises a group of nodes which are connected together in a manner which allows electronic communication such that information may be exchanged between the nodes. A node is anything which is connected to a network and is normally a computer or a printer. A number of network topologies is known, one of which is the so-called star network in which each node is connected to a central device called a hub. The hub can receive signals from any node in the network and pass it to the other nodes in the network. The hub does not perform any function of filtering data and is simply a junction for joining all the nodes together in order to ensure communication. Typically each node in the network includes a network port which can be connected to network wiring running to the hub.

As all nodes In the network are connected to each other it will be appreciated that severe damage could be caused if a large electrical surge is allowed to enter the network as it could be conducted to all nodes in the network. In severe instances it could take several days to repair the damage to the network and to restore communication between all nodes. This could result in large capital expenditure, loss of data and a substantial loss of working hours.

Electrical surges of extreme magnitude caused by lightning hits pose a constant threat to electronic equipment and therefore various devices have already been developed for protecting computer networks. It is however envisaged that a demand may exist for an alternative means for protecting equipment which are linked to each other in a network.

It is an object of the invention to provide an alternative network protector.

### SUMMARY OF THE INVENTION

According to a first aspect of the present invention there is provided a network protector comprising:
node connecting means for connecting the network protector to a node in an electronic network;
hub connecting means for connecting the network protector to a hub in the electronic network; and
a non-earthed surge protection circuit for allowing electronic communication between the node connecting means and the hub connecting means, the surge protection circuit including circuit breaking means for disrupting electronic communication between the node connecting means and the hub connecting means upon a surge exceeding a predetermined magnitude being received by the surge protection circuit.

Typically the node connecting means and the hub connecting means are RJ9, RJ11 or RJ45 connectors.

In a first embodiment of the invention the node connecting means comprises an RJ45 socket for receiving network wiring in the form of a network cable from a network port of a node and the hub connecting means comprises an RJ45 plug for connecting into an RJ45 port of a network hub. The surge protection circuit comprises a first circuit having a first leg which connects contact position one of the RJ45 hub plug with contact position one of the RJ45 node socket as well as a second leg which connects contact position two of the RJ45 hub plug with contact position two of the RJ45 node socket. A first circuit breaking means is formed by having a resistor in the first and second leg and connecting a capacitor between the legs. Upon receiving an electrical surge exceeding a predetermined value either the capacitor or the resistors will be destroyed thereby disrupting any electronic communication between the node and the hub.

The surge protection circuit further comprises a second circuit having a first leg which connects contact position three of the RJ45 hub plug with contact position three of the RJ45 node socket as well as a second leg which connects contact position six of the RJ45 hub plug with contact position six of the RJ45 node socket. A second circuit breaking means is formed by having a resistor in the first and second leg and of the second circuit and connecting a capacitor between the legs. Upon receiving an electrical surge exceeding a predetermined value the second capacitor or the resistors will be destroyed thereby disrupting any electronic communication between the node and the hub.

In an alternative embodiment of the network protector the surge protection circuit comprises a first leg which connects contact position one of the RJ45 hub plug with contact position one of the RJ45 node socket, a second leg which connects contact position two of the RJ45 hub plug with contact position two of the RJ45 node socket, a third leg which connects contact position three of the RJ45 hub plug with contact position three of the RJ45 node socket as well as a fourth leg which connects contact position six of the RJ45 hub plug with contact position six of the RJ45 node socket. Each leg includes a resistor which will be destroyed upon receiving an electrical surge exceeding a predetermined value thereby disrupting any electronic communication between the node and the hub.

According to a second aspect of the invention there is provided a method of protecting a network comprising the step of providing a network protector between a node in the network and a hub of the network, the network protector including an non-earthed surge protection circuit having circuit breaking means which disrupts electronic communication between the hub and the node upon the network protector receiving an electrical surge exceeding a predetermined magnitude.

According to a third aspect of the invention there is provided a network comprising a node, a hub, network wiring providing electronic communication between the node and the hub and a network protector connected between the hub and the network wiring for disrupting electronic communication between the node and the hub upon an electrical surge exceeding a predetermined magnitude being received by the network protector.

According to a fourth aspect of the invention there is provided a network protector comprising:
a first node connecting means for connecting the network protector to a first node in an electronic network;
a second node connecting means for connecting the network protector to a second node in the electronic network; and
a non-earthed surge protection circuit for allowing electronic communication between the first node connecting means and the second node connecting means, the surge protection circuit including circuit breaking means for disrupting electronic communication between the first node connecting means and the second node connecting means upon a surge exceeding a predetermined magnitude being received by the surge protection circuit.

### BRIEF DESCRIPTION OF THE DRAWINGS

The invention will now be described in more detail, by way of example only, with reference to the accompanying drawings wherein:

FIG. 1 shows a perspective view of a network protector in accordance with the invention;

FIG. 2 shows a bottom view of the network protector;

FIG. 3 shows a schematic representation of a star network incorporating network protectors of the invention;

FIG. 4 shows a circuit diagram of a network protector in accordance with the invention;

FIG. 5 shows a second circuit diagram of a network protector in accordance with the invention having an alternative surge protection circuit;

FIG. 6 shows a third circuit diagram of a network protector of the invention having an alternative port configuration;

FIG. 7 shows a fourth circuit diagram of a network protector of the invention having an alternative port configuration for connection to a telecommunications network on one side and an electronic network on the other side;

FIG. 8 shows a fifth circuit diagram of a network protector of the invention having yet a further port configuration wherein a PABX system is in communication with a digital port; and

FIG. 9 shows a sixth circuit diagram of a network protector wherein all eight wires of a node port and a hub port are utilised.

### DESCRIPTION OF THE ILLUSTRATED EMBODIMENTS

In the specification and drawings like reference numerals indicate like components.

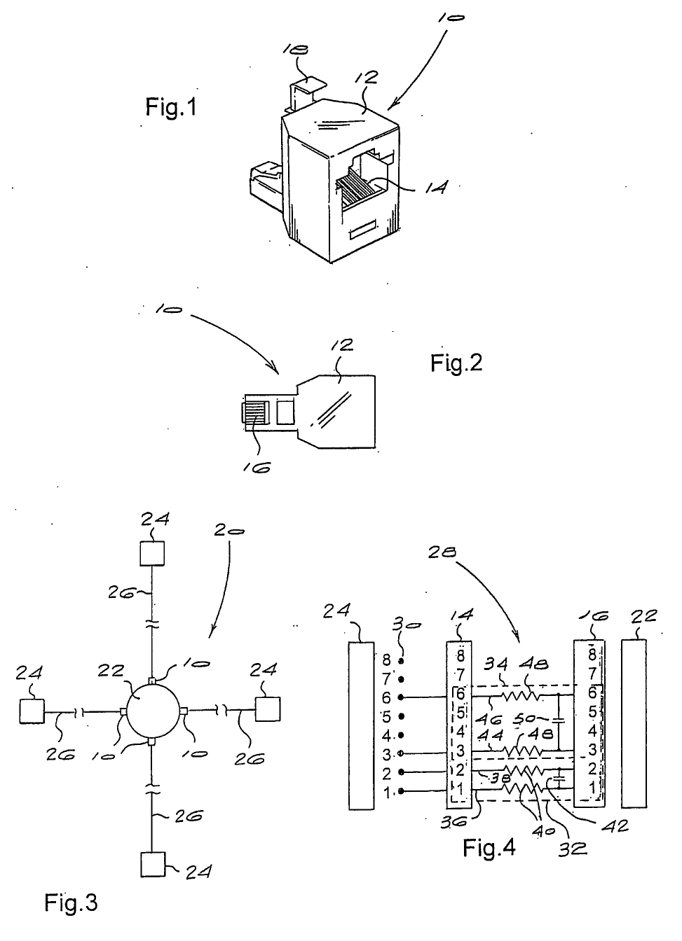

FIG. 1 and FIG. 2 show a network protector according to the invention, generally indicated with the reference numeral 10. The network protector 10 comprises a housing 12 having a node connecting means 14, here in the form of an RJ45 socket, for connection to network wiring running from a node in an electronic network. The network protector 10 further comprises a hub connecting means 16, in this embodiment in the form of an RJ45 plug. A release mechanism 18 is provided for releasing the network protector from a hub in an electronic network should it become necessary to replace the network protector.

FIG. 3 shows an electronic network 20, here a computer network in a star topology, having a hub 22 which is in electronic communication with a number of nodes 24, here in the form of computers. Each node 24 is connected to a network protector 10 via network wiring 26. Typically the network wiring comprises a number of network cables which are connected to the network ports of the computers. Although not shown in the drawings, a hub in a computer network normally includes a light for each node connected thereto for indicating whether electronic communication exist between a specific node and the hub.

Persons skilled in the art will understand that an RJ45 connector includes eight contact positions. In this specification the contact positions are numbered by holding an RJ45 plug with its clip, used for disconnecting the plug from a socket, facing upwards and numbering from left to right starting with the number 1. Persons skilled in the art will also be aware that a network cable comprises 4 pairs of twisted wires which are colour-coded. With the present numbering system used, the brown wire of the cable will be connected to contact position 8, the brown/white wire to contact position 7, the green wire to contact position 6, the blue/white wire to contact position 5, the blue wire to contact position 4, the green/white wire to contact position 3, the orange wire to contact position 2 and the orange/white wire to contact position 1.

FIG. 4 shows a circuit diagram of a non-earthed surge protection circuit 28 which is housed inside the housing 12 and which connects the node connecting means 14 with the hub connecting means 16. As mentioned the node connecting means 14 is in the form of an RJ45 socket while the hub connecting means is in the form of an RJ45 plug. The node connecting means 14 is shown to be connected to a network port 30 of a computer 24 in the network 20 with electronic communication being provided by contact positions 1, 2, 3 and 6 of the network port 30 and the node connecting means 14. The other contact positions, i.e. positions 4, 5, 7, and 8, are not assigned and subsequently do not transmit or received data.

The non-earthed surge protection circuit 28 comprises a first circuit 32 and a second circuit 34. The first circuit 32 has a first leg 36 which connects contact position one of the RJ45 plug 16 with contact position one of the RJ45 socket 14, as well as a second leg 38 which connects contact position two of the RJ45 plug 16 with contact position two of the RJ45 socket 14. A first circuit breaking means is formed by having a resistor 40 in the first and second legs 36 and 38 and connecting a capacitor 42 between the legs. Upon receiving an electrical surge between the first leg 36 and the second leg 38 which exceeds a predetermined value of either the resistors 40 or the capacitor 42, the resistors or the capacitor will be destroyed thereby disrupting any electronic communication between the node 24 and the hub 22. In this embodiment the capacitor is a 2 kV470pf through-hole capacitor having a 5% variance.

The second circuit 34 of the surge protection circuit 28 comprises a first leg 44 which connects contact position three of the RJ45 plug 16 with contact position three of the RJ45 socket 14 as well as a second leg 46 which connects contact position six of the RJ45 plug 16 with contact position six of the RJ45 socket 14. A second circuit breaking means is formed by having a resistor 48 in the first and second legs 44 and 46 and connecting a capacitor 50 between the legs. Upon receiving an electrical surge between the first leg 44 and the second leg 46 which exceeds the predetermined value of the resistors 48 or the capacitor 50, either the resistors or the capacitor 50 will be destroyed thereby disrupting any electronic communication between the node 24 and the hub 22. By destroying the means for electronic communication the electrical surge will not be able to travel through the network to cause damage.

The surge protection circuit 28 will typically be suitable for networks operating between 1-100 megabytes.

As mentioned above a hub normally includes a light for each node in the network for indicating whether there is electronic communication between the hub and a specific node. Upon one of the circuit breaking means of the network protector being destroyed, electronic communication between that specific node and the hub will be disrupted and the light on the hub associated with that node will indicate that the network protector is faulty. The network protector can then simply be replaced in order to reestablish communication.

During trials it was noticed that the use of the network protector in a network leads to an increase in the apparent efficiency of the network. The reason for this is that the resistors of the surge protection circuit seem to remove unwanted noise.

An added feature of the network protector is that it can indicate faulty wiring in a network. This is possible due to the fact that the network protector will only allow a light on the hub, associated with a specific node, to light-up if the wiring leading to the network protector is correct.

Persons skilled in the art will further appreciate that a network card in a computer could have a port configuration which differs from the port configuration described above, i.e. by not using contact positions 1, 2, 3 and 6 but other contact positions. Such changes also fall within the scope of the invention and some examples of alternative port configurations are discussed below.

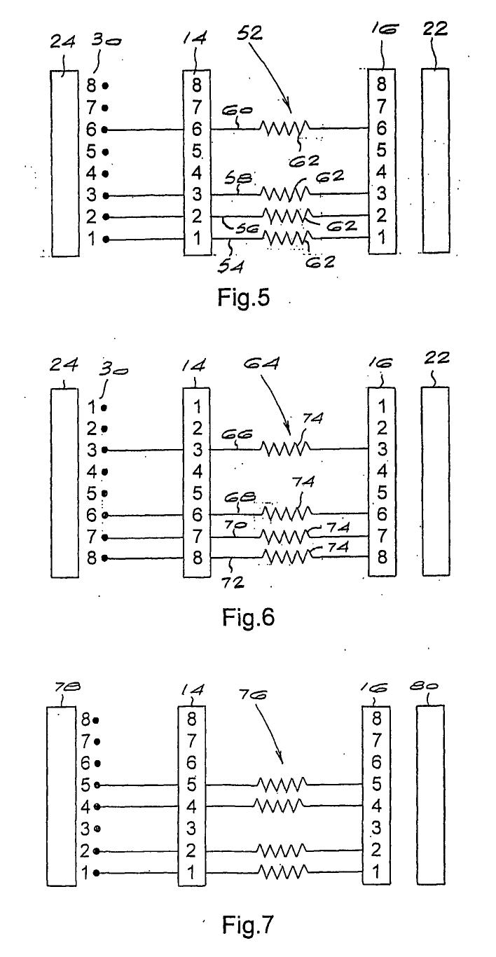

FIG. 5 shows a circuit diagram of an alternative non-earthed surge protection circuit 52 for connecting the node connecting means 14 of the node 24 with the hub connecting means 16 of the hub 22. As in the previous embodiment the node connecting means 14 is in the form of an RJ45 socket while the hub connecting means 16 is in the form of an RJ45 plug. The node connecting means 14 is again connected to a network port 30 of a computer 24 with electronic communication being provided by contact positions 1, 2, 3 and 6 of the network port 30 and the node connecting means 14.

In this embodiment the surge protection circuit 52 comprises a first leg 54 which connects contact position one of the RJ45 plug 16 with contact position one of the RJ45 socket 14. The surge protection circuit 52 further comprises a second leg 56 which connects contact positions two, a third leg 58 which connects contact positions three and a fourth leg 60 which connects contact positions four of the RJ45 plug 16 and the RJ45 socket 14 respectively. Each leg 54, 56, 58 and 60 includes a circuit breaking means 62, here provided in the form of a resistor. When an electrical surge which exceeds the predetermined value of the resistors 62 are received by the legs, the resistors will be destroyed, thereby disrupting any electronic communication between the node 24 and the hub 22. As with the surge protection circuit 28, contact positions 4, 5, 7 and 8 of the surge protection circuit 52 are not assigned and do therefore not transmit or receive data.

FIG. 6 shows a circuit diagram of a further non-earthed surge protection circuit 64 for connecting the node connecting means 14 with the hub connecting means 16. As in the previous embodiments the node connecting means 14 is in the form of an RJ45 socket while the hub connecting means is in the form of an RJ45 plug. The node connecting means 14 is yet again connected to a network port 30 of a computer 24. In this embodiment however electronic communication is provided by contact positions 3, 6, 7 and 8 of the network port 30 and the node connecting means 14. As with the surge protection circuit 52 of FIG. 5, the surge protection circuit 64 comprises four legs 66, 68, 70 and 72 which connect the contact positions. Each leg 66, 68, 70 and 72 again includes a circuit breaking means in the form of a resistor 74 which will be destroyed in the event of a surge being received which exceeds the predetermined value of the resistors 74.

FIG. 7 shows a non-earthed surge protection circuit 76 which operates in the same manner as the surge protection circuit 52 and 64 of FIGS. 5 and 6 respectively. In this embodiment however contact positions 1, 2, 4 and 5 are assigned for transmitting and receiving data respectively. This configuration is typically used by the South African telecommunications company Telkom Limited and the embodiment of the network protector shown in FIG. 7 is installed between a telecommunications line 78 and a 2 megabyte network link 80. This configuration could also be used for connecting an ISDN (integrated services digital network) line to a network link.

It is pointed out that the network link 80 could also be a microwave link.

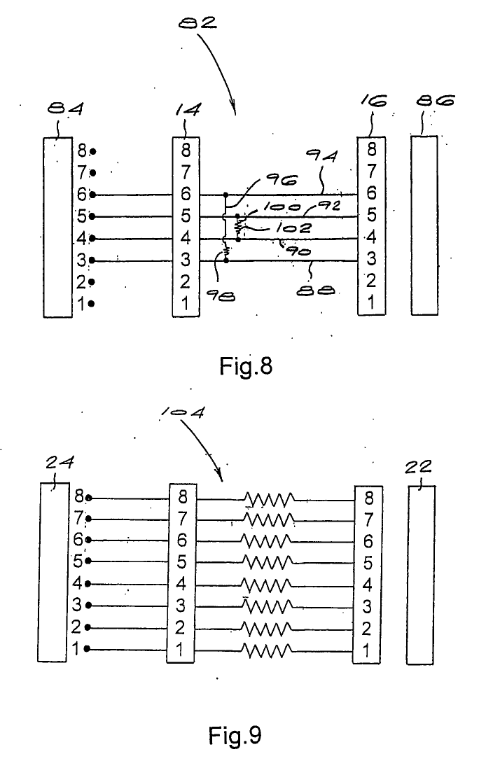

FIG. 8 shows a further embodiment of a non-earthed surge protection circuit 82. Here contact positions 3, 4, 5 and 6 are assigned for transmitting and receiving data respectively and four legs 88, 90, 92 and 94 connect the respective contact positions. The circuit breaking means of this embodiment is formed by connecting legs 88 and 94 with a leg 96 which includes a resistor 98. The circuit breaking means also includes a leg 100 which connects legs 90 and 92. The leg 100 includes a resistor 102. When the surge protection circuitry 82 receives a surge exceeding a predetermined magnitude the resistors will be destroyed thereby terminating electronic communication and preventing damage to the network.

The configuration of FIG. 8 is commonly used by the international company trading under the name Philips. The shown surge protection circuit 82 is suitable for connecting a PABX (private automatic branch exchange) line 84 with a digital port 86.

In FIG. 9 a non-earthed surge protection circuit 104 is shown for use in a network protector of the invention wherein all eight contact positions should be assigned to either receive or transmit data between the hub 22 and the node 24. The configuration of FIG. 9 will typically be employed for a 1 gigabyte network.

During testing it was found that the above embodiments operated well when making use of 100 ohm 0.25 Watt resistors with a 10% variance. Persons skilled in the art will appreciate that by employing resistors in the surge protection circuit additional load is added to the network. By making use of these 100 ohm resistors a good balance is struck between the load that is added and the magnitude of surges which will cause communication to break down.

Although specific reference has been made to RJ45 connectors it would be appreciated that the irivention could also be used for RJ9 and RJ11 connectors.

It will be appreciated that the invention extends to six line configurations.

It will further also be appreciated that the network protector of the invention could be used for providing non-earthed surge protection between nodes in a network. In such cases however the surge protection circuit of the first embodiment employing capacitors will not be suitable as the capacitors could cause the network connection to become unstable.

It is pointed out that it is preferable that the network protector of FIG. 4 be installed next to the of a network hub in order to increase stability.

Although not shown, a network protector for connection between two nodes in a network will comprises a first node connecting means for connecting the network protector to a first node in an electronic network and a second node connecting means for connecting the network protector to a second node in the electronic network. Such a network protector will further include a non-earthed surge protection circuit for allowing electronic communication between the first node connecting means and the second node connecting means.

The surge protection circuit will also include circuit breaking means for disrupting electronic communication between the first node connecting means and the second node connecting means. Typically the surge protection circuit employed in a network protector for connection between nodes will be similar to those employed in FIGS. 5 to 9 of the drawings.

In the described embodiments the hub connecting means 16 of the network protector 10 has been provided in the form of a plug, shown in FIG. 1 and FIG. 2. It is however envisaged that the hub connecting means could also be provided in the form of a socket, not shown. A separate connector cable, also not shown, can then be used to connect the hub connecting means with the hub. It is envisaged that a network protector having two sockets could prove to be more versatile than a network protector employing a plug and a socket.

A network protector in accordance with the present invention provides an alternative to existing network surge protectors.

1. A network protector comprising:
node connecting means for connecting the network protector to a node in an electronic network;
hub connecting means for connecting the network protector to a hub in the electronic network; and
a non-earthed surge protection circuit for allowing electronic communication between the node connecting means and the hub connecting means, the surge protection circuit including circuit breaking means for disrupting electronic communication between the node connecting means and the hub connecting means upon a surge exceeding a predetermined magnitude being received by the surge protection circuit.

2. A network protector according to claim 1 wherein the node connecting means and the hub connecting means are RJ9, RJ11 or RJ45 connectors.

3. A network protector according to claim 2 wherein the node connecting means comprises an RJ45 connector for connecting with network wiring from a network port of a node.

4. A network protector according to claim 3 wherein the hub connecting means comprises an RJ45 connector for connecting to an RJ45 connector of a network hub.

5. A network protector according to claim 4 wherein the surge protection circuit comprises a first circuit having a first leg which connects contact position one of the RJ45 hub connector with contact position one of the RJ45 node connector as well as a second leg which connects contact position two of the RJ45 hub connector with contact position two of the RJ45 node connector.

6. A network protector according to claim 5 wherein a first circuit breaking means is provided between the first and the second leg of the first circuit.

7. A network protector according to claim 6 wherein the circuit breaking means is formed by having a resistor in the first and second leg and a capacitor connected between the legs such that upon receiving an electrical surge exceeding a predetermined value either the capacitor or the resistors will be destroyed thereby disrupting any electronic communication between the node and the hub.

8. A network protector according to claim 5 wherein the surge protection circuit comprises a second circuit having a first leg which connects contact position three of the RJ45 hub connector with contact position three of the RJ45 node connector socket as well as a second leg which connects contact position six of the RJ45 hub connector with contact position six of the RJ45 node connector.

9. A network protector according to claim 8 wherein a second circuit breaking means is provided between the first and the second leg of the second circuit.

10. A network protector according to claim 9 wherein the second circuit breaking means is formed by having a resistor in the first and second leg of the second circuit and a capacitor connected between these legs such that upon receiving an electrical surge exceeding a predetermined value either the capacitor or the resistors will be destroyed thereby disrupting any electronic communication between the node and the hub.

11. A network protector according to claim 4 wherein the surge protection circuit comprises a first leg which connects contact position one of the RJ45 hub connector with contact position one of the RJ45 node connector, a second leg which connects contact position two of the RJ45 hub connector with contact position two of the RJ45 node connector, a third leg which connects contact position three of the RJ45 hub connector with contact position three of the RJ45 node connector as well as a fourth leg which connects contact position six of the RJ45 hub connector with contact position six of the RJ45 node connector.

12. A network protector according to claim 11 wherein each leg includes circuit breaking means which will be destroyed upon receiving an electrical surge exceeding a predetermined value thereby disrupting any electronic communication between the node and the hub.

13. A network protector according to claim 12 wherein the circuit breaking means are resistors.

14. A network protector according to claim 13 wherein the resistors are 100 ohm 0.25 Watt resistors with a 10% variance.

15. A network protector according to claim 4 wherein the surge protection circuit comprises a first leg which connects contact position three of the RJ45 hub connector with contact position three of the RJ45 node connector, a second leg which connects contact position six of the RJ45 hub connector with contact position six of the RJ45 node connector, a third leg which connects contact position seven of the RJ45 hub connector with contact position seven of the RJ45 node connector as well as a fourth leg which connects contact position eight of the RJ45 hub connector with contact position eight of the RJ45 node connector.

16. A network protector according to claim 4 wherein the surge protection circuit comprises a first leg which connects contact position one of the RJ45 hub connector with contact position one of the RJ45 node connector, a second leg which connects contact position two of the RJ45 hub connector with contact position two of the RJ45 node connector, a third leg which connects contact position four of the RJ45 hub connector with contact position four of the RJ45 node connector as well as a fourth leg which connects contact position five of the RJ45 hub connector with contact position five of the RJ45 node connector.

17. A network protector according to claim 4 wherein the surge protection circuit comprises eight legs wherein each contact position of the RJ45 hub connector is connected with its corresponding contact position of the RJ45 node connector.

18. A network protector according to claim 15 wherein each leg includes circuit breaking means which will be destroyed upon receiving an electrical surge exceeding a predetermined value thereby disrupting any electronic communication between the node and the hub.

19. A network protector according to claim 18 wherein the resistors are 100 ohm 0.25 Watt resistors with a 10% variance.

20. A network protector according to claim 4 wherein the surge protection circuit comprises a first leg which connects contact position three of the RJ45 hub connector with contact position three of the RJ45 node protector, a second leg which connects contact position four of the RJ45 hub connector with contact position four of the RJ45 node connector, a third leg which connects contact position five of the RJ45 hub connector with contact position five of the RJ45 node connector as well as a fourth leg which connects contact position six of the RJ45 hub connector with contact position six of the RJ45 node connector.

21. A network protector according to claim 20 wherein the surge protection circuit includes that the first and fourth legs are connected with a leg having a resistor.

22. A network protector according to claim 20 wherein the surge protection circuit includes that the second and third legs are connected with a leg having a resistor.

23. A network protector according to claim 22 wherein the resistors are 100 ohm 0.25 Watt resistors with a 10% variance.

24. A network protector comprising:
a first node connecting means for connecting the network protector to a first node in an electronic network;
a second node connecting means for connecting the network protector to a second node in the electronic network; and
a non-earthed surge protection circuit for allowing electronic communication between the first node connecting means and the second node connecting means, the surge protection circuit including circuit breaking means for disrupting electronic communication between the first node connecting means and the second node connecting means upon a surge exceeding a predetermined magnitude being received by the surge protection circuit.

25. A network protector according to claim 24 wherein the first node connecting means comprises a first RJ45 connector and the second node connecting means comprises a second RJ45 connector.

26. A network protector according to claim 25 wherein the surge protection circuit comprises a first leg which connects contact position three of the first RJ45 connector with contact position three of the second RJ45 connector, a second leg which connects contact position four of the first RJ45 connector with contact position four of the second RJ45 connector, a third leg which connects contact position five of the first RJ45 connector with contact position five of the second RJ45 connector as well as a fourth leg which connects contact position six of the first RJ45 connector with contact position six of the second RJ45 connector.

27. A network protector according to claim 26 wherein the first node is a telecommunications line and the second node is a 2 megabyte link.

28. A network protector according to claim 26 wherein the surge protection circuit includes that the first and fourth legs are connected with a leg having a resistor.

29. A network protector according to wherein the surge protection circuit includes that the second and third legs are connected with a leg having a resistor.

30. A network protector according to claim 25 wherein the surge protection circuit comprises a first leg which connects contact position three of the first RJ45 connector with contact position three of the second RJ45 connector, a second leg which connects contact position four of the first RJ45 connector with contact position four of the second RJ45 connector, a third leg which connects contact position five of the first RJ45 connector with contact position five of the second RJ45 connector as well as a fourth leg which connects contact position six of the first RJ45 connector with contact position six of the second RJ45 connector.

31. A network protector according to claim 30 wherein the first node is a PABX line and the second node is a digital port.

32. A network protector according to claim 30 wherein each leg includes a circuit breaking means which will be destroyed upon receiving an electrical surge exceeding a predetermined value thereby disrupting any electronic communication between the node and the hub.

33. A network protector according to claim 32 wherein the circuit breaking means are resistors.

34. A network protector according to claim 33 wherein the resistors are 100 ohm 0.25 Watt resistors with a 10% variance.

35. A network comprising a node, a hub, network wiring providing electronic communication between the node and the hub and a network protector connected between the hub and the network wiring, the network protector comprising:
node connecting means for connecting the network wiring to the network protector;
hub connecting means for connecting the network protector to the hub; and
a non-earthed surge protection circuit for allowing electronic communication between the node connecting means and the hub connecting means, the surge protection circuit including circuit breaking means for disrupting electronic communication between the node connecting means and the hub connecting means upon a surge exceeding a predetermined magnitude being received by the surge protection circuit.

36. A network comprising a first node, a second node and a network protector connected between the first node and the second node, the network protector comprising:
a first node connecting means for connecting the first node to the network protector;
a second node connecting means for connecting the second node to the network protector; and
a non-earthed surge protection circuit for allowing electronic communication between the first node connecting means and the second node connecting means, the surge protection circuit including circuit breaking means for disrupting electronic communication between the first node connecting means and the second node connecting means upon a surge exceeding a predetermined magnitude being received by the surge protection circuit.

37. A method of protecting a network comprising the step of providing a network protector between a node in the network and a hub of the network, the network protector including a non-earthed surge protection circuit having circuit breaking means which disrupts electronic communication between the hub and the node upon the network protector receiving an electrical surge exceeding a predetermined magnitude.

38. (canceled)

39. (canceled)

40. A network protector according to claim 16 wherein each leg includes circuit breaking means which will be destroyed upon receiving an electrical surge exceeding a predetermined value thereby disrupting any electronic communication between the node and the hub.

41. A network protector according to claim 40 wherein the resistors are 100 ohm 0.25 Watt resistors with a 10% variance.
